(19) United States
(12) Patent Application Publication
(10) Pub. No.: US 2009/0306241 A1
(43) Pub. Date: Dec. 10, 2009

(54) COATING SUBSTANCE, METHOD FOR THE PRODUCTION THEREOF AND USE THEREOF IN THE PRODUCTION OF TRANSPARENT, CORROSION-INHIBITING COATINGS

(75) Inventors: Maxime Allard, Munster (DE); Thomas Reher, Munster (DE)

Correspondence Address: BASF CORPORATION;Patent Department, 1609 BIDDLE AVENUE, MAIN BUILDING, WYANDOTTE, MI, 48192, US

(73) Assignee: BASF COATINGS AG, Munster (DE)

(21) Appl. No.: 10/596,082

(22) PCT Filed: Nov. 25, 2004
(86) PCT No.: PCT/EP2004/053156

§ 371 Date: Aug. 19, 2009

(30) Foreign Application Priority Data
Dec. 13, 2003 (DE) 103 58 488.9

(51) Int. Cl. C08J 3/28

(52) U.S. Cl. 522/83; 977/773

(57) ABSTRACT

A liquid coating material which is curable with actinic radiation and is substantially or completely free from organic solvents and from corrosion-inhibiting pigments, including
(A) at least one constituent which is one of a low molecular mass, oligomeric organic compounds, low molecular mass polymeric organic compounds said oligomeric and polymeric compounds containing at least one group which can be activated with actinic radiation, or air-drying and oxidatively drying alkyd resins,
(B) at least one constituent which is an acidic esters of polyphosphoric acid, or acidic esters of monophosphoric acid and at least one compound (b1), said compound containing at least one hydroxyl group and at least one group which can be activated with actinic radiation, and
(C) at least one kind of nanoparticles.

The present invention relates to a novel coating material curable with actinic radiation. The present invention further relates to a novel process for preparing a coating material curable with actinic radiation. The present invention additionally relates to the use of the novel coating material or of the coating material prepared by means of the novel process to produce transparent corrosion-inhibiting coatings, particularly coil coatings, especially primer coats.

In order to produce firmly adhering corrosion-inhibiting coatings on metal strips or coils, particularly those made of the conventional utility metals, such as zinc, aluminum or bright, galvanized, electrolytically zinked, and phosphated steel, by means of the coil coating process (Römpp Lexikon Lacke und Druckfarben, Georg Thieme Verlag, Stuttgart, New York, 1998, page 617, “Roller coating”, and page 55, “Coil coating”) it is necessary to pretreat the surface of the metal coils. As part of the coil coating process, however, this represents an additional step, which it would be desirable to avoid on economic and technical grounds.

As is known, primer coats serve to promote adhesion between the metal surface and the coatings lying above it. To a certain extent they may also contribute to corrosion protection. They are normally produced from pigmented, solventborne, thermally curable coating materials. However, this necessitates complex units for the suction withdrawal and disposal of the emitted solvents, and the coils must be heated to high temperatures (peak metal temperatures, PMT) in order to cure the applied coating materials at the speed which is necessary for the coil coating process. It would therefore be highly desirable to have available solvent-free coating materials rapidly curable with actinic radiation for the production of primer coats.

Pigmented coating materials curable with actinic radiation and intended for producing corrosion-inhibiting coatings, especially coil coatings, more particularly corrosion-inhibiting primer coats, are known. They normally comprise olefinically unsaturated, acidic phosphoric and/or polyphosphoric esters and corrosion-inhibiting zinc, aluminum and/or zinc-molybdenum phosphate and pyrophosphate pigments.

The known pigmented coating materials curable with actinic radiation, however, have a comparatively high viscosity and therefore cannot be applied in the coil coating process without problems, or at all, by means of roller application. Instead, relatively high application temperatures and/or comparatively complicated extrusion units with slot dies must be employed, both of which are disadvantageous for the coil coating process.

Moreover, the corrosion-inhibiting phosphate and pyrophosphate pigments react with the acidic phosphoric and polyphosphoric esters, with the consequence that the known such pigmented coating materials curable with actinic radiation have a processing life of only 10 to 20 days and must be used in the form of two-component systems. For cements used to produce corrosion protection coats for steel edges, and for coating materials intended for producing corrosion protection coats for weld seams, however, preference is given to using one-component systems.

It is the case not least that the known pigmented coating materials curable with actinic radiation do not produce transparent coatings, especially clear coatings, which are able to maintain or even intensify the visual impression of bright metal surfaces.

It is an object of the present invention to provide a novel coating material curable with actinic radiation and substantially or completely free from organic solvents which no longer has the disadvantages of the prior art but which instead
is easy to prepare,
is highly reactive and yet storage-stable,
can be prepared, transported, stored, and processed as a one-component system,
can be applied with particular ease without problems in particular by the coil coating process, and
can be cured at low temperatures, very rapidly, and without emission of volatile organic compounds.

The novel coating material curable with actinic radiation and completely free or substantially free from organic solvents is intended to provide transparent coatings, especially clear coatings, particularly coil coatings, and especially primer coatings, which, even on nonpretreated metal surfaces, especially the surface of utility metals, such as zinc, aluminum, or bright, galvanized, electrolytically zinked, and phosphated steel, exhibit
particularly high adhesion,
particularly high intercoat adhesion to the overlying coatings,
outstanding corrosion protection, especially against white rust, and
a high elasticity, even in the form of thin films, and which
maintain or even intensify the visual impression of bright metal surfaces

The novel coating material curable with actinic radiation and substantially or completely free from organic solvents ought in particular to be suitable as cement for producing corrosion protection coats for steel edges and for producing corrosion protection coats for weld seams.

The invention accordingly provides the novel liquid coating material which is curable with actinic radiation and is substantially or completely free from organic solvents and from corrosion-inhibiting pigments, comprising
(A) at least one constituent selected from the group consisting of low molecular mass, oligomeric, and polymeric organic compounds which contain at least one group which can be activated with actinic radiation, and also air-drying and oxidatively drying alkyd resins,
(B) at least one constituent selected from the group consisting of acidic esters of polyphosphoric acid and of monophosphoric acid with at least one compound (b1) containing at least one hydroxyl group and at least one group which can be activated with actinic radiation, and
(C) at least one kind of nanoparticles.

The novel liquid coating material which is curable with actinic radiation and is substantially or completely free from organic solvents and from corrosion-inhibiting pigments is referred to below as “coating material of the invention”.

Further subject matter of the invention will emerge from the description

In the light of the prior art it was surprising and unforeseeable for the skilled worker that the object on which the present invention was based could be achieved by means of the coating material of the invention

In particular, the coating material of the invention no longer had the disadvantages of the prior art, but instead
was easy to prepare,
was highly reactive and yet storage-stable,
could be prepared, transported, stored, and processed as a one-component system,
could be applied with particular ease without problems in particular by the coil coating process, and
could be cured at low temperatures, very rapidly, and without emission of volatile organic compounds.

The coating material of the invention gave transparent coatings, especially clear coatings, particularly coil coatings, especially primer coatings, which, even on nonpretreated metal surfaces, particularly the surface of utility metals, such as zinc, aluminum, or bright, galvanized, electrolytically zinked, and phosphated steel, exhibited
particularly high adhesion,
particularly high intercoat adhesion to the overlying coatings,
outstanding corrosion protection, especially against white rust, and
a high elasticity, even in the form of thin films, and which
maintained or even intensified the visual impression of bright metal surfaces.

The coating material of the invention is liquid; that is, although containing solid, nonliquid constituents, it is nevertheless continuously in a fluid state at room temperature under the conventional conditions of preparation, storage, and application, and so can be processed by means of the conventional application methods employed in the coil coating process.

The coating material of the invention can be in the form of a water-in-oil dispersion, in which a discontinuous aqueous phase is finely dispersed in the continuous organic phase. The diameter of the droplets of the aqueous phase may vary widely; preferably it is from 10 nm to 1000 μm, in particular from 100 nm to 800 μm The constituents of the coating material of the invention are distributed between the aqueous phase and the organic phase in accordance with their hydrophilicity or hydrophobicity (cf. Römpp Online, Georg Thieme Verlag, Stuttgart, New York, 2002, “Hydrophobicity”, “Hydrophilicity”), or are present in the form of a separate solid phase.

The coating material of the invention or its aqueous phase has a pH<5, preferably <4, and in particular from 3 to 3.5

The coating material of the invention is substantially or completely free from organic solvents. That is, its organic solvent content is <5%, preferably <3%, and more preferably <1% by weight. In particular the amount is below the detection limits of the conventional qualitative and quantitative detection methods for organic solvents.

It is likewise substantially or completely, preferably completely, free from corrosion-inhibiting pigments.

The coating material of the invention includes at least one constituent (A), preferably at least two and in particular at least three constituents (A), selected from the group consisting of low molecular mass, oligomeric, and polymeric organic compounds which contain at least one, especially one or at least two, group(s) which can be activated with actinic radiation, and also air-drying and oxidatively drying alkyd resins.

By actinic radiation is meant electromagnetic radiation, such as near infrared (NIR), visible light, UV radiation, X-rays or gamma radiation, especially UV radiation, and corpuscular radiation, such as electron beams, alpha radiation, beta radiation, proton beams or neutron beams, especially electron beams.

The groups which can be activated with actinic radiation contain at least one, especially one, bond which can be activated with actinic radiation. By this is meant a bond which on exposure to actinic radiation becomes reactive and, with other activated bonds of its kind, enters into polymerization reactions and/or crosslinking reactions which proceed in accordance with free-radical and/or ionic mechanisms. Examples of suitable bonds are carbon-hydrogen single bonds or carbon-carbon, carbon-oxygen, carbon-nitrogen, carbon-phosphorus or carbon-silicon single bonds or double bonds or carbon-carbon triple bonds. Of these, the carbon-carbon double bonds and triple bonds are advantageous and are therefore used with preference in accordance with the invention. The carbon-carbon double bonds are particularly advantageous and so are used with particular preference. For the sake of brevity they are referred to below as “double bonds”.

The double bonds are preferably contained in groups of the general formula I:

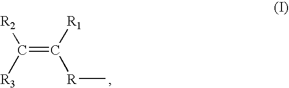

In the general formula I the variables have the following meanings:
R is a carbon-carbon single bond to the carbon atom of a carbonyloxy group or a divalent organic radical, preferably a carbon-carbon single bond; and
R¹, R², and R³ are each a hydrogen atom or an organic radical;
   it being possible for at least two of the radicals R, R¹, R², and R³ to be linked cyclically to one another.

Examples of suitable divalent organic radicals R include or consist of alkylene, cycloalkylene and/or arylene groups. Highly suitable alkylene groups include a carbon atom or 2 to 6 carbon atoms. Highly suitable cycloalkylene groups contain 4 to 10, especially 6, carbon atoms. Highly suitable arylene groups contain 6 to 10, especially six, carbon atoms.

Examples of suitable organic radicals R¹, R², and R³ include or consist of alkyl, cycloalkyl and/or aryl groups. Highly suitable alkyl groups contain one carbon atom or 2 to 6 carbon atoms. Highly suitable cycloalkyl groups contain 4 to 10, especially 6, carbon atoms. Highly suitable aryl groups contain 6 to 10, especially 6, carbon atoms.

The organic radicals R, R¹, R², and R³ may be substituted or unsubstituted. However, the substituents must not interfere with the preparation of the coating material of the invention and/or inhibit the activation of the groups with actinic radiation. The organic radicals R, R¹, R², and R³ are preferably unsubstituted.

Examples of especially suitable groups of the general formula I are vinyl, 1-methylvinyl, 1-ethylvinyl, propen-1-yl, styryl, cyclohexenyl, endomethylenecyclohexyl, norbornenyl, and dicyclopentadienyl groups, especially vinyl groups.

Accordingly, the particularly preferred groups which can be activated with actinic radiation are (meth)acrylate, ethacrylate, crotonate, cinnamate, cyclohexenecarboxylate, endomethylenecyclohexanecarboxylate, norbornenecarboxylate, and dicyclopentadienecarboxylate groups, but especially (meth)acrylate groups.

Examples of highly suitable low molecular mass compounds (A) are conventional reactive diluents (cf. Römpp Online, Georg Thieme Verlag, Stuttgart, New York, 2002, “Reactive diluents”). The reactive diluents are preferably selected from the group consisting of isobornyl acrylate, dicyclopentenyloxyethyl acrylate, N-(2-methacryloyleth-1-yl)ethyleneurea, 4-hydroxybutyl acrylate glycidyl ether, Ebecryl® CL1039 monoacryloylcarbamate or Genomer® M 22 monoacryloylcarbamate, 4-hydroxybutyl acrylate, hydroxyethyl acrylate, trimethylolpropane triacrylate, tetrahydrofurfuryl monoacrylate, cyclic trimethylolpropane formal monoacrylate (CTF monoacrylate), dicyclopentadienyl acrylate (Fancryl® FA 512 from Hitachi), CN 131 epoxy-propoxy-monoacrylate from Craynor, ethylene glycol diacrylate, and diethylene glycol diacrylate.

Oligomeric organic compounds (A) generally contain 2 to 15 monomeric building blocks; polymeric organic compounds (A) generally contain more than 10 monomeric building blocks (cf. also Römpp Online, 2002, “Oligomers”, “Polymers”).

The oligomeric and polymeric organic compounds (A) may hail from any of a very wide variety of oligomer and polymer classes. Examples of suitable oligomer and polymer classes are random, alternating and/or block, linear and/or branched and/or comb polyaddition resins, polycondensation resins, and (co)polymers of ethylenically unsaturated monomers. For further details of these terms refer to Römpp Lexikon Lacke und Druckfarben, Georg Thieme Verlag, Stuttgart, New York, 1998, page 457, “Polyaddition” and “Polyaddition resins (polyadducts)”, and also pages 463 and 464, “Polycondensates”, “Polycondensation”, and “Polycondensation resins”.

Examples of highly suitable polyaddition resins and/or polycondensation resins (A) are polyesters, alkyds, polyurethanes, polylactones, poly-carbonates, polyethers, epoxy resin-amine adducts, polyureas, poly-amides, and polyimides.

Examples of highly suitable (co)polymers (A) are (meth)acrylate (co)polymers and polyvinyl esters, especially (meth)acrylate copolymers. Highly suitable (meth)acrylate copolymers (A) are, for example, the commercial products Craynor® PRO 6021 (dendrimeric acrylated oligomer from Craynor), XDE 1025 and 1029 from Bomar Specialties, or the acrylated methacrylate copolymers having a double bond functionality of 2.3 to 4.6 and a glass transition temperature of −23 to +15° C.

Particular preference is given to using oligourethanes and polyurethanes (A). These are obtainable from conventional diisocyanates and polyisocyanates and from compounds containing at least one, especially one, isocyanate-reactive functional group and at least one, especially one, of the above-described groups which can be cured with actinic radiation.

Suitable diisocyanates and polyisocyanates include basically all of the conventional aliphatic, cycloaliphatic, aliphatic-cycloaliphatic, aromatic, aliphatic-aromatic and/or cycloaliphatic-aromatic diisocyanates and polyisocyanates and polyisocyanate adducts that are used in the paints field, which are also referred to as paint polyisocyanates.

Examples of suitable diisocyanates are isophorone diisocyanate (i e., 5-isocyanato-1-isocyanatomethyl-1,3,3-trimethylcyclohexane), 5-isocyanato-1-(2-isocyanatoeth-1-yl)-1,3,3-trimethylcyclohexane, 5-isocyanato-1-(3-isocyanatoprop-1-yl)-1,3,3-trimethylcyclohexane, 5-isocyanato-(4-isocyanatobut-1-yl)-1,3,3-trimethylcyclohexane, 1-isocyanato-2-(3-isocyanatoprop-1-yl)cyclohexane, 1-isocyanato-2-(3-isocyanatoeth-1-yl)cyclohexane, 1-isocyanato-2-(4-isocyanatobut-1-yl)cyclohexane, 1,2-diisocyanatocyclobutane, 1,3-diisocyanatocyclobutane, 1,2-diisocyanatocyclopentane, 1,3-diisocyanatocyclopentane, 1,2-diisocyanatocyclohexane, 1,3-diisocyanatocyclohexane, 1,4-diisocyanatocyclohexane, dicyclohexylmethane 2,4′-diisocyanate, dicyclohexylmethane 4,4′-diisocyanate, liquid dicyclohexylmethane 4,4′-diisocyanate with a trans/trans content of up to 30% by weight, preferably 25% by weight, and in particular 20% by weight, which is obtainable by phosgenating isomer mixtures of bis(4-aminocyclohexyl)methane or by fractionally crystallizing commercially customary bis(4-isocyanatocyclohexyl)methane in accordance with patents DE 44 14 032 A1, GB 1220717 A, DE 16 18 795 A1 or DE 17 93 785 A1; trimethylene diisocyanate, tetramethylene diisocyanate, pentamethylene diisocyanate, hexamethylene diisocyanate, ethylethylene diisocyanate, trimethylhexane diisocyanate, heptamethylene diisocyanate or diisocyanates derived from dimer fatty acids as sold under the commercial designation DDI 1410 by Henkel and described in patents WO 97/49745 A and WO 97/49747 A, especially 2-heptyl-3,4-bis(9-isocyanatononyl)-1-pentylcyclohexane, 1,2-, 1,4- or 1,3-bis(isocyanatomethyl)cyclohexane, 1,2-, 1,4- or 1,3-bis(2-isocyanatoeth-1-yl)cyclohexane, 1,3-bis(3-isocyanatoprop-1-yl)cyclohexane or 1,2-, 1,4- or 1,3-bis(4-isocyanatobut-1-yl)cyclohexane, m-tetramethylxylylene diisocyanate (i.e., 1,3-bis(2-isocyanatoprop-2-yl)-benzene, tolylene diisocyanate or diphenylmethane diisocyanate.

Examples of suitable polyisocyanates based on the above-described diisocyanates are isocyanato-containing polyurethane prepolymers prepared by reacting polyols with an excess of at least one of the above-described diisocyanates, and/or polyisocyanates containing isocyanurate, biuret, allophanate, iminooxadiazinedione, urethane, urea and/or uretdione groups. It is preferred to use polyisocyanates having on average from 2 to 5 isocyanate groups per molecule and viscosities of 100 to 10000, preferably 100 to 5000, mPas. Moreover, the polyisocyanates may have been subjected to conventional hydrophilic or hydrophobic modification.

Examples of suitable preparation processes are known, for example, from patents CA 2,163,591 A, U.S. Pat. No. 4,419,513, U.S. Pat. No. 4,454,317 A, EP 0 646 608 A, U.S. Pat. No. 4,801,675 A, EP 0 183 976 A1, DE 40 15 155 A1, EP 0 303 150 A1, EP 0 496 208 A1, EP 0 524 500 A1, EP 0 566 037 A1, U.S. Pat. No. 5,258,482 A1, U.S. Pat. No. 5,290,902 A1, EP 0 649 806 A1, DE 42 29 183 A1 or EP 0 531 820 A1.

Also suitable are the high-viscosity polyisocyanates as described in German patent application DE 198 28 935 A1.

Examples of suitable isocyanate-reactive functional groups are hydroxyl groups, thiol groups, and primary and secondary amino groups, especially hydroxyl groups.

Examples of especially suitable compounds containing an isocyanate-reactive functional group and a group which can be activated with actinic radiation are monomers which carry at least one hydroxyl or amino group per molecule, such as
hydroxyalkyl esters of acrylic acid, methacrylic acid or another alpha,beta-olefinically unsaturated carboxylic acid which derive from an alkylene glycol which is esterified with the acid or which are obtainable by reacting the alpha,beta-olefinically unsaturated carboxylic acid with an alkylene oxide such as ethylene oxide or propylene oxide, especially hydroxyalkyl esters of acrylic acid, methacrylic acid, ethacrylic acid, crotonic acid, maleic acid, fumaric acid or itaconic acid, in which the hydroxyalkyl group contains up to 20 carbon atoms, such as 2-hydroxyethyl, 2-hydroxypropyl, 3-hydroxypropyl, 3-hydroxybutyl, 4-hydroxybutyl acrylate, methacrylate, ethacrylate, crotonate, maleate, fumarate or itaconate; or methylpropanediol monoacrylate, monomethacrylate, monoethacrylate, monocrotonate, monomaleate, monofumarate or monoitaconate; or hydroxycycloalkyl esters such as cyclohexanedimethanol, 1,4-bis(hydroxymethyl)cyclohexane, 1,4-dihydrocyclohexane or octahydro-4,7-methano-1H-indene-dimethanol monoacrylate, monomethacrylate, monoethacrylate, monocrotonate, monomaleate, monofumarate or monoitaconate; or the reaction products of all these hydroxyalkyl or hydroxycycloalkyl esters with cyclic esters, such as epsilon-caprolactone, for example;
olefinically unsaturated alcohols such as allyl alcohol;
polyols such as trimethylolpropane monoallyl or diallyl ether or pentaerythritol monoallyl, diallyl or triallyl ether;
reaction products of acrylic acid and/or methacrylic acid with the glycidyl ester of an alpha-branched monocarboxylic acid having 5 to 18 carbon atoms per molecule, especially of a Versatic® acid, or instead of the reaction product an equivalent amount of acrylic and/or methacrylic acid which is then reacted, during or after the polymerization reaction, with the glycidyl ester of an alpha-branched monocarboxylic acid having 5 to 18 carbon atoms per molecule, in particular a Versatic® acid;
aminoethyl acrylate, aminoethyl methacrylate, allylamine or N-methyliminoethyl acrylate; and/or
acryloyloxysilane-containing vinyl monomers, preparable by reacting hydroxy-functional silanes with epichlorohydrin and then reacting the reaction product with (meth)acrylic acid and/or hydroxyalkyl and/or hydroxycycloalkyl esters of (meth)acrylic acid and/or further hydroxyl-containing monomers.

In particular, 4-hydroxybutyl acrylate is used.

The reaction of the diisocyanates and polyisocyanates with the compounds having at least one isocyanate-reactive functional group and at least one group which can be activated with actinic radiation has no special features in terms of method but is instead carried out, for example, as described in international patent application WO 96/23836 A.

Highly suitable acrylated oligourethanes (A) are, for example, the commercial products Photomer® 6623 and 6891 from Cognis, Ebecryl® 8210 from UCB, Craynor® 9001 and CN 957 from Craynor, and Doublemer® 86A from Double Bond Chemical.

Air-drying and oxidatively drying alkyd resins (A), such as linseed oil, soybean oil, safflower oil or ricinene alkyd resins, are compounds known per se and are described for example in Römpp Online, 2002, “Alkyd resins”. Preferred alkyd resins are those with an oil length or oil content of 20 to 60%, in particular 25 to 60%. 45 to 65 eq. %, in particular 48 to 60 eq %, of the olefinically unsaturated double bonds present in the unsaturated fatty acid residues of the alkyd resin (A) are conjugated. On account of its oil length or oil content, the alkyd resin is also referred to as a medium-oil or medium-fatty alkyd resin.

The unsaturated fatty acid residues of the alkyd resins (A) are derived from unsaturated fatty acids, such as lauroleic acid (dodecenoic acid), myristoleic acid (tetradecenoic acid), palmitoleic acid (hexadecenoic acid), oleic acid (octadecenoic acid), gadoleic acid (eicosenoic acid), erucic acid (docosenoic acid), ricinoleic acid (12-hydroxyoctadecenoic acid), linoleic acid (octadecenoic acid), linolenic acid (octadecatrienoic acid), elaeostearic acid, eicosapentenoic acid or docosahexaenoic acid, which are found in and/or can be obtained from vegetable and animal oils, such as castor oil, dehydrated castor oil, coconut oil, palm oil, groundnut oil, cottonseed oil, soybean oil, safflower oil, sunflower oil, OH sunflower oil, linseed oil, high erucic acid and low erucic acid colza oil, wood oil, oiticica oil, lard, tallow, sperm oil, and herring oil.

The unsaturated fatty acids are commercial products and are sold, for example, by UNIQEMA under the brand names Prifac® or Dedico®, by Henkel under the brand name Isomerginsaure® or by Akzo under the brand name Nouracid®.

The amount of fatty acid residues (oil length) and of fatty acid residues containing conjugated double bonds can easily be adjusted by the skilled worker by way of the amount of fatty acids in total and by way of the ratio of olefinically unsaturated fatty acids without conjugated double bonds to olefinically unsaturated fatty acids with conjugated double bonds.

As is known, the alkyd resins (A) are prepared from polyols and polybasic carboxylic acids and the abovementioned oxidatively drying fatty acids.

Examples of suitable polyhydric alcohols are glycerol, pentaerythritol, trimethylolethane, and trimethylolpropane.

Examples of suitable polybasic carboxylic acids are tetrahydrophthalic and hexahydrophthalic acid, methylnadic acid, methylendomethylene- and 3,6-endomethylenetetrahydrophthalic acid, and also the corresponding anhydrides of these acids.

The alkyd resins (A) may also be in modified form, having been modified with at least one modifying component, such as oils, natural resins, phenolic resins, acrylic resins, styrene, epoxy resins, silicone resins or isocyanates.

The alkyd resins (A) are commercial products and are sold, for example, under the brand name Alkydal® R 35 by Bayer AG or Italkyd® R35 by Multi Resin. The alkyd resins (A) are preferably solvent-free in the sense described above or are freed from organic solvents by means, for example, of distillation.

Particularly advantageous coating materials of the invention comprise the above-described reactive diluents (A), the oligomers and polymers (A), and the alkyd resins (A).

Especially advantageous coating materials of the invention contain, based on their total amount, preferably
5 to 40%, preferably 10 to 35%, and in particular 15 to 30% by weight of at least one reactive diluent (A),
5 to 40%, preferably 10 to 35%, and in particular 10 to 30% by weight of at least one oligomer and/or polymer (A), and
5 to 40%, preferably 10 to 35%, and in particular 10 to 30% by weight of at least one alkyd resin (A).

The coating material of the invention comprises as constituent (B) at least one, especially one, acidic ester of polyphosphoric acid and/or monophosphoric acid, especially polyphosphoric acid, and at least one compound (b1) containing at least one, especially one, hydroxyl group and at least one group which can be activated with actinic radiation.

The diphosphorus pentoxide content of the polyphosphoric acid may vary widely; preferably it is from 60 to 95% by weight, more preferably from 70 to 95% by weight, and in particular from 70 to 90% by weight.

Examples of suitable groups which can be activated with actinic radiation are those described above.

Examples of suitable compounds (b1) are the above-described hydroxyl-containing olefinically unsaturated monomers. In particular use is made of cyclohexanedimethanol monoacrylate (CDMMA), tricyclododecanedimethanol monoacrylate (TDDMMA), and 4-hydroxybutyl acrylate.

The constituents (B), based on their total amount, contain preferably 10 to 25% by weight and in particular 15 to 20% by weight of diphosphorus pentoxide.

Particularly advantageous coating materials of the invention contain, based on their total amount, preferably from 10 to 50% by weight, more preferably from 15 to 45% by weight, and in particular from 20 to 40% by weight of at least one constituent (B).

The coating material of the invention further comprises at least one, especially one, kind of nanoparticles as constituent (C) It is preferred to use inorganic nanoparticles (C).

The nanoparticles (C) are preferably selected from the group consisting of main group and transition group metals and their compounds. The main group and transition group metals are preferably selected from metals of main groups 3 to 5 and transition groups 3 to 6 and 1 and 2 of the periodic table of the elements, and also the lanthanides. Particular preference is given to using boron, aluminum, gallium, silicon, germanium, tin, arsenic, antimony, silver, zinc, titanium, zirconium, hafnium, vanadium, niobium, tantalum, molybdenum, tungsten, and cerium, especially aluminum, silicon, silver, cerium, titanium, and zirconium.

The compounds of the metals are preferably the oxides, oxide hydrates, sulfates or phosphates.

Preference is given to using silver, silicon dioxide, aluminum oxide, aluminum oxide hydrate, titanium dioxide, zirconium oxide, cerium oxide, and mixtures thereof, more preferably silver, cerium oxide, silicon dioxide, aluminum oxide hydrate and mixtures thereof, very preferably silicon dioxide, and in particular pyrogenic silica.

The nanoparticles (C) preferably have a primary particle size <50 nm, more preferably 5 to 50 nm, in particular 10 to 30 nm.

The nanoparticles (C) can be used in solid form or, preferably, as a suspension in one of the above-described reactive diluents (A), especially monofunctional reactive diluents (A). In this context the reactive diluents (A) are to be included in the composition of the coating material of the invention.

The amount of nanoparticles (C) in the coating material of the invention is preferably 1 to 25% by weight, more preferably 2 to 20% by weight, and in particular 3 to 15% by weight, based in each case on the coating material.

Furthermore, the coating material of the invention may comprise at least one additive (D), in particular at least two additives (D), in effective amounts.

Additive (D) is preferably selected from the group consisting of epoxide compounds, polyphosphoric acids, dryers, nonopaque organic and inorganic, colored and achromatic, optical effect, electrically conductive, magnetically shielding, and fluorescent pigments, antisetting agents, oligomeric and polymeric binders other than the constituents (A), UV absorbers, light stabilizers, free-radical scavengers, photoinitiators, devolatilizers, slip additives, polymerization inhibitors, defoamers, emulsifiers and wetting agents, adhesion promoters, leveling agents, film formation auxiliaries, rheology control additives, and flame retardants, especially epoxide compounds and photoinitiators.

Examples of suitable photoinitiators (D) are known from Römpp Online, Georg Thieme Verlag, Stuttgart, New York, 2002, “Photoinitiators”.

Examples of suitable epoxide compounds (D) are aromatic compounds containing epoxide groups, especially bisphenol A, bisphenol F, hydrogenated bisphenol A, hydrogenated bisphenol F, and tricyclododecanedimethanol diglycidyl ether. The aromatic epoxide compounds (D) can be used together with small amounts—that is, <20% by weight, based on the epoxide compounds (D)—of low molecular mass, aliphatic epoxide compounds (D).

In the coating material of the invention, the epoxide compounds (D) are present preferably in an amount of 1 to 20% by weight, more preferably 5 to 17% by weight, and in particular 5 to 15% by weight, based in each case on the coating material.

Based on its total amount, the coating material of the invention contains preferably 1 to 10%, more preferably 1.5 to 8%, in particular 2 to 6% by weight of organically bonded diphosphorus pentoxide.

The coating material of the invention is prepared preferably by mixing the above-described constituents in suitable mixing equipment such as stirred tanks, stirred mills, extruders, kneading apparatus, Ultraturrax, inline dissolvers, static mixers, micromixers, toothed wheel dispersers, pressure release nozzles and/or microfluidizers. It is preferred here to operate in the absence of light with a wavelength λ<550 nm or in complete absence of light, in order to prevent premature crosslinking.

The coating materials of the invention are one-component systems outstandingly suitable for the production of coatings of all kinds.

In particular they are suitable as coil coating materials and also as cements for producing corrosion-inhibiting coatings for steel edges and as corrosion-inhibiting coatings for weld seams. Moreover, they are outstandingly suitable for producing coatings on all utility metals, in particular on bright steel, galvanized, electrolytically zinked, and phosphated steel, zinc, and aluminum, on coatings, especially primer coatings, and on SMC (sheet molded compounds) and BMC (bulk molded compounds).

The coatings of the invention are outstandingly suitable as clearcoats, topcoats, temporary or permanent protective coats, primer coats, sealing coats, and antifingerprint coats, but especially as primer coats.

In terms of method, the application of the coating materials of the invention has no special features but can instead take place by any conventional application method, such as spraying, knifecoating, brushing, flowcoating, dipping, trickling or rolling, for example. Generally speaking it is advisable to operate in the absence of actinic radiation, in order to prevent premature crosslinking of the coating materials of the invention. Following application, the water contained in the coating material of the invention can be evaporated in a simple manner, this also being referred to as flash-off. This is preferably done by the brief inductive heating of the metal substrates.

Radiation sources suitable for curing the applied coating materials of the invention with actinic radiation include sources such as high or low pressure mercury vapor lamps or electron beam sources. Further examples of suitable methods and apparatus for curing with actinic radiation are described in German patent application DE 198 18 735 A1, column 10 line 31 to column 11 line 22, by R. Stephen Davidson in “Exploring the Science, Technology and Applications of U.V. and E.B. Curing”, Sita Technology Ltd., London, 1999, Chapter I, “An Overview”, page 16, FIG. 10, or by Dipl.-Ing., Peter Klamann in “eltosch System-Kompetenz, UV-Technik, Leitfaden für Anwender”, page 2, October 1998.

For irradiation it is preferred to use a radiation dose from 100 to 6000, preferably 200 to 3000, more preferably 300 to 2500, and with particular preference 500 to 2000 mJ cm⁻².

The radiation intensity may vary widely. It is guided in particular by the radiation dose on the one hand and the irradiation time on the other. For a given radiation dose, the irradiation time is guided by the belt speed or speed of advance of the substrates in the irradiation unit and vice versa. The radiation intensity is preferably 1×10⁰ to 3×10⁵, more preferably 2×10⁰ to 2×10⁵, with particular preference 3×10⁰ to 2.5×10⁵ and in particular 5×10⁰ to 2×10⁵W m⁻².

It is a particular advantage of the coating material of the invention that the radiation cure can be assisted by oxidative curing in air. It is a further particular advantage of the coating material of the invention that it can also be cured only partly and in this state can be overcoated with at least one further coating material, in particular with a coating material curable with actinic radiation, after which all applied films can be cured together using actinic radiation. By this means the process times are shortened further, and the intercoat adhesion is further improved. Overall, owing to the use of the coating material of the invention, it is no longer necessary in the coil coating process to heat the metal sheets to PMTs of 240° C. or more. Also unnecessary is the suction withdrawal and disposal of volatile organic compounds, so allowing the expenditure in terms of apparatus, safety technology, and energy to be reduced significantly.

The resulting coatings of the invention are highly flexible, very highly deformable without damage, resistant to chemicals, stable to weathering, resistant to condensation and salt water, and of high adhesion to the substrates and to other coatings. They combine all of these features with an outstanding visual appearance.

### EXAMPLES

### Example 1

The preparation of a coating material curable with actinic radiation

The coating material was prepared by mixing 20 parts by weight of an alkyd resin (75% strength by weight in isobornyl acrylate) with an oil length of 28%, a mass-average molecular weight of 10 000 to 12 000 daltons, and a molecular weight polydispersity <5, based on hexahydrophthalic acid and modified sunflower oil FA, having a conjugated double bond content of 48 to 62 eq. %, based on the number of double bonds present (Edenor® 6010 from Henkel), 30 parts by weight of a polyphosphoric ester of cyclohexanedimethanol monoacrylate (CDMMA) (prepared by reacting 80 parts by weight of CDMMA and 20 parts by weight of polyphosphoric acid with a diphosphorus pentoxide content of 84% by weight), 20 parts by weight of a commercial oligomeric urethane acrylate (Photomer® 6623 from Cognis), 10 parts by weight of 4-hydroxybutyl acrylate glycidyl ether, 22 parts by weight of a 50% by weight suspension of silica nanoparticles in CTF monoacrylate from BASF AG (Nanocryl ® XP 21-765 from Hanse Chemie), and 4 parts by weight of a commercial photoinitiator (Irgacure® 184 from Ciba Specialty Chemicals) and homogenizing the resulting mixture in an Ultraturrax for 20 minutes at a rotational speed of 1800.

The coating material contained organically bonded diphosphorus pentoxide in an amount of 4.8% by weight, based on the coating material. The coating material was fully stable on storage in the absence of actinic radiation. It was outstandingly suitable for producing primer coatings.

### Examples 2 and 3

The production of coatings using the coating material from Example 1

### Example 2

The substrates used were degreased, nonpretreated steel panels made of EZ (electrolytically zinked) and HDG (hot dipped galvanized) steel from Chemetall. The coating material was applied to the substrates using an S3 doctor blade in a film thickness of 3 μm The resulting films were cured with UV radiation in a dose of 500 mJ cm⁻².

Already after aging for 12 hours the resultant coatings withstood 100 double rubs with a cotton pad soaked with methyl ethyl ketone.

The coatings were scribed and subjected to the salt spray test. The sample panels in question showed no severe adverse alterations, such as delamination or white rust, after 168 hours; all that was observed was a scribe creep of 2 mm and an edge creep of 1 mm. The panels were therefore rated satisfactory (sat.).

The coatings were additionally overcoated with a conventional polyester/melamine resin-based coil coating material from BASF Coatings AG. The resultant coating films were cured at 240° C. PMT for 35 minutes. The resulting coatings allowed a very high degree of deformation without problems (T-bend test: EZ substrates: 1; HDG substrates: 1.5) and exhibited outstanding substrate adhesion and intercoat adhesion (tape test: EZ substrates: 0.5; HDG substrates: 0.5 to 1) and a high corrosion protection effect (salt spray test 21 days: all substrates: scribe creep <2 mm; edge creep 0 to 1 mm, rating sat.).

### Example 3

The substrates used were steel panels of CRS (cold rolled steel), PVD (phase vapor deposition)-coated CRS, and HDG steel.

The coating material of Example 1 was applied to the substrates in film thicknesses 14 μm, 20 μm, and 32 μm using S14, S20, and S32 doctor blades. The resulting films were cured with UV radiation in a dose of 1500 mJ cm⁻².

Even the 14 μm coatings on HDG steel withstood, after scribing, 21 days of salt spray testing without exhibiting white rust. The unscribed coatings remained clear and unaltered. Surprisingly, the coatings met the requirements of class IV of the specification by the company Usinor for components for exterior use without pretreatment of the substrates, without corrosion-inhibiting pigments, and without a thermal aftercure.

The 20 μm coatings on CRS and PVD-CRS withstood 21 days of salt spray testing without exhibiting white rust, the scribe creep was 5 mm and the edge creep from 0 to 3 mm, The unscribed coatings 20 μm thick showed no change during the salt spray test. In the case of the scribed coatings 32 μm thick the scribe creep was 5 mm and the edge creep was 0 to 1 mm.

The overall finding was, surprisingly, that the unscribed coatings afforded very good corrosion protection without zinc plating and without a pretreatment.

### Example 3

As described in Example 2, the coating material of Example 1 was used to produce coatings 4 to 6 μm thick on PVD-CRS, HDG, and EZ steel and also on Galvalume® (a zinc-aluminum alloy). The coatings were of high gloss (>80 units) and enhanced the metallic appearance. The coatings on Galvalume® and PVD-CRS in particular resulted in a particularly attractive decorative effect The scratch resistance of the coatings was high. They were resistant to steel wool. After 1000 cycles in the abrasion resistance test (two CS 10 rubber abrasive rollers with precious stone abrasive powder or alumina; applied weight: 1000 g per arm) they suffered a loss of weight of only 3 mg in each case. Under the conditions of the conventional scratch tests, such as the AMTEC carwash test or the brush test, they suffered no scratching. They were easy to color and could be used for decorative interior components.

### Example 4

The preparation of an epoxy-functional coating material curable with actinic radiation

10 parts by weight of hydrogenated bisphenol A diglycidyl ether were added to the coating material of Example 1, and the resulting mixture was homogenized.

In the absence of actinic radiation the coating material had a processing life of 20 hours. It was outstandingly suitable for producing primer coatings.

### Example 5

The production of coatings with the coating material of Example 4

The substrates used were degreased unpretreated steel panels of EZ steel and HDG steel from Chemetall. The coating material was applied to the substrates in a film thickness of 3 μm using an S3 doctor blade. The resulting films were cured with UV radiation in a dose of 500 mJ cm⁻².

Even at this low film thickness the resulting coatings exhibited a high corrosion protection effect (salt spray test: no white rust even after 7 days) and were highly elastic (T-bend test: 2) even without afterbaking.

1. A liquid coating material which is curable with actinic radiation and is substantially or completely free from organic solvents and from corrosion-inhibiting pigments, comprising
(A) at least one constituent selected from the group consisting of low molecular mass, oligomeric organic compounds, low molecular mass polymeric organic compounds said oligomeric and polymeric compounds containing at least one group which can be activated with actinic radiation, air-drying and oxidatively drying alkyd resins,
(B) at least one constituent selected from the group consisting of acidic esters of polyphosphoric acid, acidic esters of monophosphoric acid with at least one compound (b1), said compound containing at least one hydroxyl group and at least one group which can be activated with actinic radiation, and
(C) at least one kind of nanoparticles.

2. The coating material as claimed in claim 1, containing, based on its total weight, 1 to 10% by weight of organically bonded diphosphorus pentoxide.

3. The coating material as claimed in claim 1, characterized in that the low molecular mass organic compounds (A) are reactive diluents.

4. The coating material as claimed in claim 1, characterized in that the oligomeric or polymeric compounds (A) are oligourethanes or polyurethanes.

5. The coating material as claimed in claim 1, characterized in that the air-drying and oxidatively drying alkyd resin (A) has an oil content of 20 to 60%, based on the alkyd resin (A), and 45 to 65 eq. % of the olefinically unsaturated double bonds present in the unsaturated fatty acid residues are conjugated.

6. The coating material as claimed in claim 1, characterized in that the group which can be activated with actinic radiation contains at least one bond which can be activated with actinic radiation.

7. The coating material as claimed in claim 6, characterized in that the actinic radiation is electromagnetic radiation or corpuscular radiation.

8. The coating material as claimed in claim 7, characterized in that the electromagnetic radiation embraces near infrared (NIR), visible light, UV radiation, X-rays, and gamma radiation and the corpuscular radiation embraces electron beams, proton beams, alpha radiation, beta radiation, and neutron beams.

9. The coating material as claimed in claim 1, characterized in that the bond which can be activated with actinic radiation is at least one of a carbon-carbon double bond or a triple bond.

10. The coating material as claimed in claim 9, characterized in that the bond which can be activated with actinic radiation is a carbon-carbon double bond.

11. The coating material as claimed in claim 1, characterized in that the group which can be activated with actinic radiation is a (meth)acrylate group.

12. The coating material as claimed in claim 1, characterized in that the compounds (b1) are selected from the group consisting of cyclohexanedimethanol monoacrylate (CDMMA), tricyclododecanedimethanol monoacrylate (TDDMMA), and 4-hydroxybutyl acrylate.

13. The coating material as claimed in claim 1, characterized in that the nanoparticles (C) are selected from the group consisting of silicon dioxide and aluminum oxide.

14. The coating material as claimed in claim 1, containing, based on its total weight,
5 to 40% by weight of at least one reactive diluent (A),
5 to 40% by weight of at least one oligomer or polymer (A), and
5 to 40% of at least one alkyd resin (A).

15. The coating material as claimed in claim 1, containing, based on its total amount, constituent (B) in an amount of 10 to 50% by weight.

16. The coating material as claimed in claim 1, containing, based on its total amount, nanoparticles (C) in an amount of 1 to 25% by weights.

17. The coating material as claimed in claim 1, further comprising at least one additive (D).

18. The coating material as claimed in claim 17, characterized in that the additive (D) is selected from the group consisting of epoxide compounds, polyphosphoric acids, dryers, nonopaque organic pigments, nonopaque inorganic pigments, colored pigments, achromatic pigments, optical effect pigments, electrically conductive pigments, magnetically shielding pigments, fluorescent pigments, antisettling agents, oligomeric binders, and polymeric binders other than the constituents (A), UV absorbers, light stabilizers, free-radical scavengers, photoinitiators, devolatilizers, slip additives, polymerization inhibitors, defoamers, emulsifiers and wetting agents, adhesion promoters, leveling agents, film formation auxiliaries, rheology control additives, and flame retardants.

19. The coating material as claimed in claim 18, characterized in that the epoxide compounds (D) are aromatic epoxide compounds.

20. The coating material as claimed in claim 19, characterized in that the aromatic epoxide compounds (D) are selected from the group consisting of bisphenol A diglycidyl ether, bisphenol F diglycidyl ether, hydrogenated bisphenol A diglycidyl ether, hydrogenated bisphenol F diglycidyl ether, and tricyclododecanedimethanol diglycidyl ether.

21. The coating material as claimed in claim 18, containing, based on its total weight, the epoxide compounds (D) in an amount of 1 to 20% by weight.

22. A process for preparing a coating material as claimed in claim 1 which comprises mixing at least constituents (A), (B), and (C) with one another and homogenizing the resulting mixture.

23-24. (canceled)

25. A coating material as claimed in claim 21, comprising a coil coating.

26. A coating material as claimed in claim 23, comprising a firmly adhering corrosion-inhibiting primer coating.
